(19) United States
(12) Patent Application Publication
(10) Pub. No.: US 2017/0363990 A1
(43) Pub. Date: Dec. 21, 2017

(54) IMAGE FORMING APPARATUS

(71) Applicant: CANON KABUSHIKI KAISHA, Tokyo (JP)

(72) Inventors: Yusuke Jinkoma, Susono-shi (JP); Yasutaka Yagi, Mishima-shi (JP)

(21) Appl. No.: 15/623,104

(22) Filed: Jun. 14, 2017

(30) Foreign Application Priority Data
Jun. 17, 2016 (JP) 2016-121017

(51) Int. Cl. G03G 15/16

(52) U.S. Cl. CPC G03G 15/16

(57) ABSTRACT

An image forming apparatus includes a controlling unit that executes a supply mode in which a supply toner image is formed on an image carrying member and supply toner is supplied to a contact portion between a cleaning member and the image carrying member. The controlling unit performs control such that the toner amount that is supplied to a contact portion in a supplying operation is smaller when the surface smoothness of a transfer material corresponds to a second roughness than when the surface smoothness of the transfer material corresponds to a first roughness, the second roughness being greater than the first roughness.

### BACKGROUND

### Field of the Disclosure

The present disclosure generally relates to image forming and, more particularly, to an image forming apparatus, such as a copying machine, a printer, a facsimile, or the like, that uses an electrophotographic method or an electrostatic recording method.

### Description of the Related Art

Hitherto, in an image forming apparatus using an electrophotographic method or an electrostatic recording method, a toner image is formed on an image carrying member (first image carrying member) that is a photoconductor having the form of a drum or a belt (electrophotographic photoconductor) or an electrostatic recording dielectric by performing an appropriate image forming process. The toner image is directly transferred to a transfer material (direct transfer method); or temporarily first-transferred to an intermediate transfer member (second image carrying member), and, then, is second-transferred to the transfer material (intermediate transfer method). In general, as the transfer material, various types of paper are often used.

After transferring the toner image to the transfer material from the image carrying member, such as a photoconductor, an electrostatic recording dielectric, or an intermediate transfer member, toner that could not be transferred to the transfer material remains on the surface of the image carrying member. Therefore, the remaining toner (residual toner) is cleaned off by a cleaning device.

As the cleaning device, a blade system is widely used. The blade system is a system in which a cleaning blade, which is a cleaning member in the form of a plate (blade) formed from an elastic member (here, the cleaning blade is also simply called “blade”) is brought into contact with the surface of the image carrying member, and the toner is removed from the surface of the image carrying member so as to scrape off the toner. In the cleaning device using the blade system, the material of the blade and contact conditions, such as the contact angle and the pressing load of the blade with respect to the image carrying member, are set such that desired performances can be realized.

However, even if the material and the contact conditions are set as mentioned above, faulty cleaning caused by paper dust getting stuck in a blade nip, which is a contact portion between the blade and the image carrying member, and the toner passing past the blade may occur. Accordingly, Japanese Patent Laid-Open No. 2013-101169 proposes a method of removing paper dust by supplying toner of a predetermined toner image to the blade nip. In this method, by using the cleaning blade, foreign substance accumulated near the blade nip can be easily removed from the image carrying member all at once along with the toner of the predetermined toner image supplied to the blade nip.

However, depending upon the type of transfer material that is used in image formation, the amount of paper dust that is produced from the transfer material differs greatly, as a result of which, in using a transfer material that generates a relatively large amount of paper dust, the amount of paper dust that accumulates near the blade nip becomes large. Therefore, when a transfer material that produces a large amount of paper dust is used, the probability with which faulty cleaning caused by paper dust getting caught in the blade nip occurs is higher than when an ordinary transfer material that produces a relatively small amount of paper dust is used.

### SUMMARY

Therefore, aspects of the present disclosure provide an image forming apparatus that is capable of reducing the occurrence of paper dust getting caught in a blade nip even when an image is formed on a transfer material that produces a relatively large amount of paper dust.

To this end, according to an aspect of the present disclosure, there is provided an image forming apparatus. In sum, the image forming apparatus includes an image carrying member that carries a toner image and a cleaning member that is disposed so as to contact a surface of the image carrying member and that removes toner from the surface of the image carrying member. The image forming apparatus that forms an image on a transfer material by transferring the toner image formed on the image carrying member to the transfer material includes a controlling unit configured to execute a supplying operation in which a supply toner image is formed on the image carrying member and toner of the supply toner image is supplied to a contact portion between the cleaning member and the image carrying member. The controlling unit controls an amount of toner that is supplied to the contact portion in the supplying operation such that the amount of toner is smaller when a surface smoothness of the transfer material on which the image is formed corresponds to a second roughness than when the surface smoothness of the transfer material on which the image is formed corresponds to a first roughness, the second roughness being greater than the first roughness.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus according to an embodiment.

FIG. 2 is a schematic view of the vicinity of a blade nip.

FIG. 3 is a block diagram of a general control mode of the image forming apparatus.

FIG. 4 is a flowchart schematically showing the control steps of the operation of supplying toner to the blade nip.

FIG. 5 is a schematic sectional view of an image forming apparatus according to another embodiment.

FIG. 6 is a schematic view of a detecting portion that detects the surface smoothness of a transfer material.

FIG. 7 is a block diagram of an exemplary determination processing of the surface smoothness of the transfer material.

FIGS. 8A and 8B are photographs and FIGS. 8C and 8D are schematic views of the results of detection of the surface smoothness of the transfer material.

FIG. 9 is a graph for describing the results of detection of the surface smoothness of the transfer material.

### DESCRIPTION OF THE EMBODIMENTS

An image forming apparatus according to one or more aspects of the present disclosure is described in detail below with reference to the drawings.

### First Embodiment

### 1. Overall Structure and Operation of Image Forming Apparatus

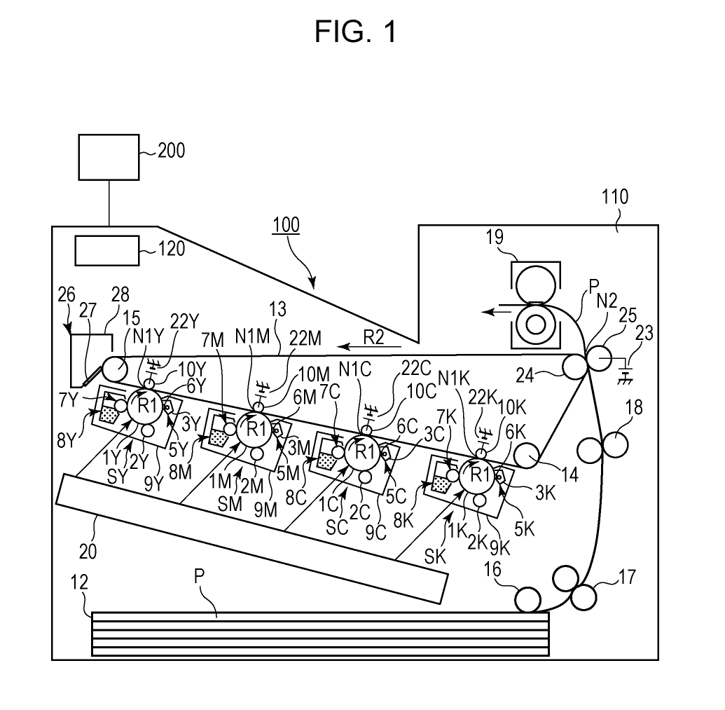

FIG. 1 is a schematic sectional view of an image forming apparatus 100 according to a first embodiment. The image forming apparatus 100 according to the embodiment is a tandem-type laser beam printer that uses an intermediate transfer method and is capable of forming a full-color image by using an electrophotographic method.

The image forming apparatus 100 includes, as a plurality of image forming units (stations), a first image forming unit SY, a second image forming unit SM, a third image forming unit SC, and a fourth image forming unit SK. The image forming unit SY, the image forming unit SM, the image forming unit SC, and the image forming unit SK form a yellow (Y) toner image, a magenta (M) toner image, a cyan (C) toner image, and a black (K) toner image, respectively.

In the embodiment, the structures and the operations of the image forming units SY, SM, SC, and SK are essentially the same except that they use different toner colors in a developing step described later. Therefore, when the image forming units do not need to be particularly distinguished, the reference characters Y, M, C, and K that indicate the corresponding color elements after the S will be omitted, and the color elements will be generically described. In this embodiment, each image forming unit S includes a photoconductor 1, a charging roller 2, an exposure device 20, a developing device 8, a first transfer roller 10, and a photoconductor cleaning device 5.

Each photoconductor having the form of a drum (photoconductor drum) 1, serving as a first image carrying member, is rotationally driven in the direction of arrow R1 (clockwise) in FIG. 1. The surface of each photoconductor 1 that rotates is uniformly charged to a predetermined electric potential (a negative polarity in the embodiment) by the corresponding charging roller 2, serving as a charging unit. When the charging step is performed, a charging voltage having a negative polarity is applied to each charging roller 2. Each exposure device 20 exposes the surface of its corresponding charged photoconductor 1 by performing scanning with laser light on the basis of image information, so that an electrostatic latent image (electrostatic image) is formed on its corresponding photoconductor 1. In the embodiment, each exposure device 20 is formed as one unit that exposes the photoconductor 1 of its corresponding image forming unit S.

Each developing device 8, serving as a developing unit, develops (makes visible) the electrostatic latent image formed on the corresponding photoconductor 1 by using toner, serving as a developer, so that a toner image is formed on the corresponding photoconductor 1. Each developing device 8 includes a developing roller 7, serving as a developer carrying member, that conveys the toner to an opposing portion (developing portion) thereof that opposes the corresponding photoconductor 1. When the developing step is performed, a predetermined developing voltage is applied to each developing roller 7. In this embodiment, toner charged to a polarity (negative polarity in this embodiment) that is the same as the charging polarity of the photoconductor 1 adheres to an exposed portion of the corresponding photoconductor 1 whose absolute value of the electric potential has been reduced by exposing the photoconductor 1 after uniformly charging the photoconductor 1.

An intermediate transfer belt 13, which serves as a second image carrying member and which is an intermediate transfer member formed from an endless belt, is disposed so as to oppose the photoconductors 1 of the corresponding image forming units S. The intermediate transfer belt 13 is placed in a tensioned state on a plurality of stretching rollers, that is, a driving roller 14, a tension roller 15, and a second-transfer opposing roller 24. The first-transfer rollers 10, serving as first-transfer units, are disposed on an inner peripheral surface side of the intermediate transfer belt 13 so as to oppose the corresponding photoconductors 1. Each first-transfer roller 10 is pushed towards the corresponding photoconductor 1 with the intermediate transfer belt 13 disposed therebetween, and forms a first-transfer portion (first-transfer nip) N1 where the photoconductor 1 and the intermediate transfer belt 13 contact each other. At the first-transfer portions N1, the toner images formed on the corresponding photoconductors 1 as described above are transferred (first-transferred) to the intermediate transfer belt 13 that is rotating in the direction of arrow R2 (counterclockwise) in FIG. 1. When the first-transfer step is performed, a first-transfer voltage having a positive polarity that is opposite to the charging polarity (normal charging polarity) of the toner when development is performed is applied to each first-transfer roller 10 from a corresponding first-transfer power supply 22. For example, when forming a full-color image, toner images of corresponding colors, that is, a yellow toner image, a magenta toner image, a cyan toner image, and a black toner image, formed on the corresponding photoconductors 1Y, 1M, 1C, and 1K, are successively transferred to the intermediate transfer belt 13 so as to be superimposed upon each other.

A second-transfer roller 25, serving as a second-transfer unit, is disposed at a location opposing the second-transfer opposing roller 24 on an outer peripheral surface side of the intermediate transfer belt 13. The second-transfer roller 25 is pushed towards the second-transfer opposing roller 24 with the intermediate transfer belt 13 disposed therebetween, and forms a second-transfer portion (second-transfer nip) N2 where the intermediate transfer belt 13 and the second-transfer roller 25 contact each other. At the second-transfer portion N2, the toner images formed on the intermediate transfer belt 13 as described above are transferred (second-transferred) to a transfer material in the form of a sheet of paper (recording material, recording medium, sheet) P that is nipped between and conveyed by the intermediate transfer belt 13 and the second-transfer roller 25. When the second-transfer step is performed, a second-transfer voltage having a positive polarity that is opposite to the normal charging polarity of the toner is applied to the second-transfer roller 25 from a second-transfer power supply 23. The transfer material P is stacked in a transfer-material cassette 12, and is conveyed to the second-transfer portion N2 by a pickup roller 16, feeding rollers 17, and conveying rollers 18.

The transfer material P to which the toner images have been transferred is conveyed to a fixing device 19, serving as a fixing unit. By heating and pressing the toner images at the fixing device 19, the toner images are fixed (melted and fixed) to a surface of the transfer material P. Thereafter, the transfer material P is discharged (output) to the outside of an apparatus main body 110 of the image forming apparatus 100.

Any residual toner remaining on the photoconductors 1 after the first-transfer step is removed and collected from the photoconductors 1 by the photoconductor cleaning devices 5 serving as photoconductor cleaning units. By using photoconductor cleaning blades 6, serving as cleaning members, that are disposed so as to contact the corresponding photoconductors, the photoconductor cleaning devices 5 scrape off the residual toner from the surfaces of the corresponding photoconductors 1 that rotate, so that the residual toner is collected by photoconductor waste-toner containers 3. Any residual toner remaining on the intermediate transfer belt 13 after the second-transfer step is removed and collected from the intermediate transfer belt 13 by a belt cleaning device 26, serving as an intermediate-transfer-member cleaning unit. The belt cleaning device 26 is described later.

In each image forming unit S, the photoconductor, the charging roller 2, the developing device 8, and the photoconductor cleaning device 5 form a process cartridge 9 that is removable together from the apparatus main body 110, with the charging roller 2, the developing device 8, and the photoconductor cleaning device 5 serving as a process unit that acts upon the photoconductor. In the embodiment, each image forming unit S constitutes a toner image forming unit that forms a toner image on the intermediate transfer belt 13.

### 2. Belt Cleaning Device

In the belt cleaning device 26, a belt cleaning blade (hereunder may also be simply referred to as “blade”), serving as a cleaning member, that is disposed in contact with the intermediate transfer belt 13, scrapes off the residual toner from the surface of the intermediate transfer belt 13 that rotates, and the residual toner is accommodated in a belt waste-toner container (hereunder, may also be simply called “waste-toner container”) 28.

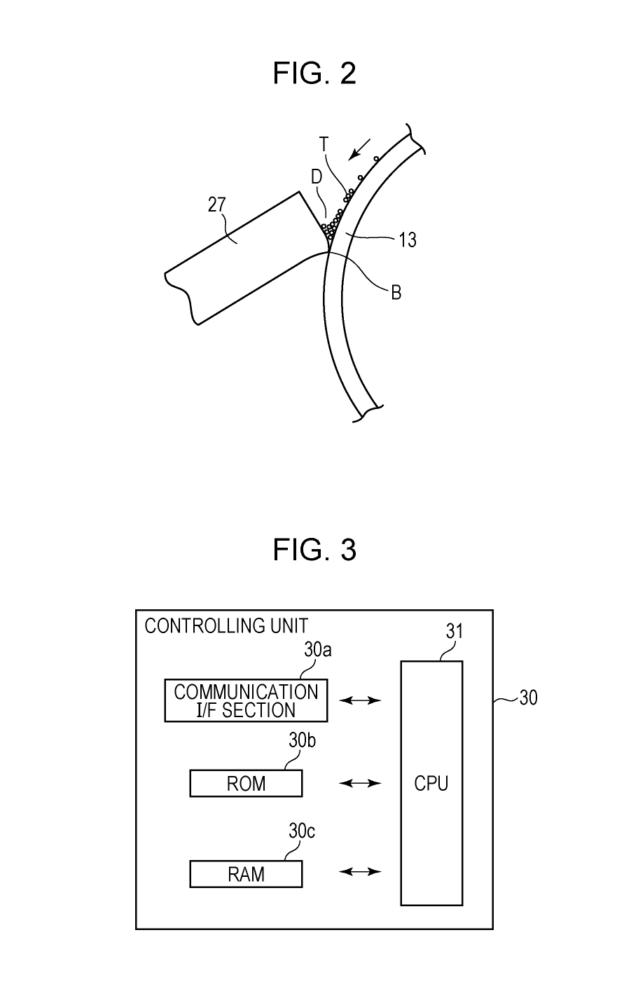

FIG. 2 is a schematic view of the vicinity of a blade nip (cleaning portion) B, which is a contact portion between the blade 27 and the intermediate transfer belt 13, when seen in a longitudinal direction of the blade 27. In the embodiment, the blade 27 is positioned so as to oppose the tension roller 15 with the intermediate transfer belt 13 disposed therebetween. The blade 27 is disposed such that its longitudinal direction is substantially parallel to the width direction of the intermediate transfer belt 13. One end portion (free end) of the blade 27 in a transverse direction contacts the surface of the intermediate transfer belt 13 in a counter direction facing an upstream side in a movement direction of the intermediate transfer belt 13.

As shown in FIG. 2, toner T on the intermediate transfer belt 13 moves towards the blade nip B from an upstream side of the intermediate transfer belt 13 in the direction of rotation thereof due to the rotation of the intermediate transfer belt 13. Then, the toner T is scraped off from the surface of the intermediate transfer belt 13 by the blade 27 at the blade nip B, and is retained near the blade nip B, more specifically, in a wedge-shaped region (accumulation portion) D between an end surface of the blade 27 and the surface of the intermediate transfer belt 13. The toner T accumulated in the accumulation portion D drops downward in FIG. 2 along an upper side surface of the blade 27 in FIG. 2, and is collected by the waste-toner container 28. Paper dust transferred (adhered) to the intermediate transfer belt B from the transfer material P when the second transfer is performed from the intermediate transfer belt 13 to the transfer material P is also removed along with the toner T by the blade 27 from the surface of the intermediate transfer belt 13 and collected by the waste-toner container 28.

In the embodiment, as the blade 27, a plate (blade) member made of polyurethane rubber, which is an example of an elastic material, is used. More specifically, the blade 27 is a plate member whose length in a longitudinal direction is 231 mm, whose length in a transverse direction is 12 mm, and whose thickness is 2 mm. The blade 27 press-contacts the intermediate transfer belt 13 with a pressing force having a linear pressure of 0.61 N/cm.

Here, the linear pressure of the blade 27 refers to the pressure per unit length of the blade 27 in the longitudinal direction thereof, and is a value obtained by dividing the total contact pressure of the blade 27 with respect to the intermediate transfer belt 13 by the length of the blade nip B in a longitudinal direction thereof. With a load converter being mounted on the intermediate transfer belt 13, the linear pressure can be determined by pushing the blade 27 against the surface of the intermediate transfer belt 13 and measuring the load thereof.

### 3. Control Mode

FIG. 3 is a block diagram of a general control mode of a main portion of the image forming apparatus 100. In the embodiment, the operation of each portion of the image forming apparatus 100 is generally controlled by a controlling unit 30 that is provided at the apparatus main body 110. The controlling unit 30, which may include one or more processors and one or more memories, includes, as main structural elements, a central processing unit (CPU) 31 (serving as a calculating and controlling unit), read only memory (ROM) 30b and random access memory (RAM) 30c (serving as storage units), a communication interface (I/F) section 30a (serving as a communication unit), etc. The units described throughout the present disclosure are exemplary and/or preferable modules for implementing processes described in the present disclosure. The modules can be hardware units (such as circuitry, a field programmable gate array, a digital signal processor, an application specific integrated circuit or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

The communication I/F section 30a may be an interface for connection to a local area network (LAN) (such as a LAN card or a LAN board), and receives print job data from an external device, such as a personal computer. The CPU 31 reads out a program from ROM 30b, and causes a printing operation based on the print job data received by the communication I/F section 30a to be smoothly executed. In relation to this embodiment, as described below, the controlling unit 30 executes a supply mode in which a predetermined toner image is formed on the intermediate transfer belt 13 at a predetermined timing and toner of the predetermined toner image is supplied to the blade nip B (paper dust removing operation).

Here, the image forming apparatus 100 executes a series of image output operations (print job, printing operation) that are started on the basis of one start instruction and that output an image formed on a single transfer material P or a plurality of transfer materials P. In general, the print job includes an image forming step, a pre-rotating step, a sheet interval step when images are formed on a plurality of transfer materials P, and a post-rotating step. The image forming step refers to a period in which an electrostatic latent image of an image that is actually formed on a transfer material P and is output is formed, a toner image is formed, the toner image is first-transferred, and the toner image is second-transferred. The phrase “when an image/images are formed” refers to this period. More specifically, the timings when an image/images are formed differ at locations where the step of forming an electrostatic latent image, the step of forming a toner image, the step of first-transferring the toner image, and the step of second-transferring the toner image are performed. The pre-rotating step refers to a period in which a preparing operation before the image forming step is performed up to when image formation is actually started from an input of a start instruction. The sheet interval step refers to a period corresponding to an interval between a transfer material P and a transfer material P when images are to be continuously formed on a plurality of transfer materials P (that is, when continuous image formation is performed). The post-rotating step refers to a period in which an adjusting operation (preparing operation) is performed after the image forming step. A non-image-forming period refers to a period other than when an image/images are formed, and includes the pre-rotating step, the sheet interval step, the post-rotating step, a multiple pre-rotating step in which a preparing operation is performed when a restoring operation is performed from a sleep state or when a power supply of the image forming apparatus 100 is turned on.

### 4. Supplying Operation

In general, in the image forming apparatus 100, various types of paper are often used as transfer materials P. When a toner image on the intermediate transfer belt 13 is second-transferred to a transfer material P at the second-transfer portion N2, part of paper dust that is produced from paper that is used as the transfer material P may be transferred to the intermediate transfer belt 13. As described above, the paper dust that has been transferred to the intermediate transfer belt 13 is removed along with residual toner from the surface of the intermediate transfer belt 13 by the blade 27 that is in contact with the intermediate transfer belt 13. However, part of the paper dust may get caught between the blade 27 and the intermediate transfer belt 13 at the blade nip B. In this case, faulty cleaning may occur as a result of toner passing past the blade 27 due to, for example, the formation of a gap between a surface of the blade 27 and a surface of the intermediate transfer belt 13 at the location where the paper dust is caught between the blade 27 and the intermediate transfer belt 13.

Here, the image forming apparatus 100 according to the embodiment executes the supplying operation from a developing device, which is a supplying device, at a predetermined timing in the non-image-forming period. In the supplying operation, a supply toner image, which is a predetermined toner image, is formed on the intermediate transfer belt 13. Then, supply toner, which is toner of the supply toner image, is supplied to the blade nip B as a result of the rotation of the intermediate transfer belt 13. When the supply toner is supplied to the blade nip B, foreign substance, such as paper dust, accumulated on the accumulation portion D near the blade nip B tends to be removed together with the supply toner from the intermediate transfer belt 13 by the blade 27. Therefore, by supplying a sufficient amount of supply toner with sufficient frequency to the blade nip B, it is possible to remove at least part of foreign substance, such as paper dust, which has the possibility of accumulating in the accumulation portion D near the blade nip B and getting caught in the blade nip B. Under certain circumstances, it is possible to sufficiently remove the foreign substance, such as paper dust, that has already been caught in the blade nip B. This makes it possible to suppress the occurrence of faulty cleaning caused by the paper dust being caught in the blade nip B.

### 5. Surface Smoothness and Paper Dust Amount of Transfer Material

Faulty cleaning caused by paper dust getting caught in the blade nip B greatly influences the surface smoothness and the paper dust amount of a transfer material P.

Table 1 shows the results of studying the degree of faulty cleaning when supply toner is supplied to the blade nip B by a certain amount and with a certain frequency regardless of the type of transfer material P, with comparative examples being those when control described below according to this embodiment is executed.

In this embodiment (as well as in the comparative examples), supply toner is supplied to the blade nip B for every sheet interval. In the comparative examples, unlike in the embodiment, the weight per unit area of supply toner that is supplied to the blade nip B (may also be called “placement amount” here) is 0.010 mg/cm² regardless of the type of transfer material P. In the embodiment (as well as in the comparative examples), the length of a supply toner image in a longitudinal direction (that is, a direction substantially orthogonal to the movement direction of the intermediate transfer belt 13) is 231 mm, and the length of the supply toner image in a transverse direction (that is, the movement direction of the intermediate transfer belt 13) is 4 mm.

In the embodiment, a supply toner image is formed with yellow toner at the first image forming unit SY. However, the formation of a supply toner image is not limited thereto. If appropriate, it is possible to form a supply toner image by using toner of a single color or toners of a plurality of colors at any one of the image forming units or at a plurality of image forming units. The supply toner image is formed similarly to an image that is ordinarily output, and is transferred to the intermediate transfer belt 13. In order to suppress adhesion of the supply toner image to the second-transfer roller 25 when the supply toner image passes through the second-transfer portion N2, a voltage having a negative polarity that is opposite to that when second transfer is performed (that is, the same polarity as the normal charging polarity of toner) is applied to the second-transfer roller 25. The second-transfer roller 25 may be separated from the intermediate transfer belt 13 when the supply toner image passes through the second-transfer portion N2.

The degree of faulty cleaning was examined by performing an image output durability test (paper feed test) in which predetermined images were formed on 100000 transfer materials 10 to be tested, and output. As the transfer materials P, a transfer material P No. 1 to a transfer material P No. 7 shown in Table 1 were used. The characteristics of the transfer materials P are as shown in Table 1.

The surface smoothnesses of the transfer materials P were measured by using a Beck smoothness meter (KUMAGAI RIKI KOGYO Co., Ltd.). The Beck smoothness is measured on the basis of the inflow speed (time) of air that flows in from a gap between a transfer material P and a rubber material in close contact therewith. Therefore, a large value indicates that the surface of the transfer material P is smooth, whereas a small value indicates that the surface of the transfer material P is rough. Here, a surface smoothness of a transfer material P where the Beck smoothness is less than 20 sec corresponds to “rough”, a surface smoothness of a transfer material P where the Beck smoothness is greater than or equal to 40 sec corresponds to “smooth”, and a surface smoothness of a transfer material P where the Beck smoothness is greater than or equal to 20 sec and less than 40 sec corresponds to “ordinary”.

By using the transfer materials P whose surface smoothnesses were to be measured, the amount of paper dust was determined on the basis of the weight percentage of calcium (Ca) contained in residual toner in the waste-toner container 28 after 10000 sheets of images having a printing ratio (image area ratio) of 5% were output. A paper dust amount of a transfer material P where the Ca weight percentage is greater than or equal to 2.5% indicates that the paper dust amount is “large”, a paper dust amount of a transfer material P where the Ca weight percentage is less than 1.5% indicates that the paper dust amount is “small”, and a paper dust amount of a transfer material P where the Ca weight percentage is greater than or equal to 1.5% and less than 2.5% indicates that the paper dust amount is “ordinary”.

TABLE 1

| | | | Image | | Paper | |
|---|---|---|---|---|---|---|
| Transfer | | Basis | Formation | Surface | Dust | Faulty |
| Material | Size | Weight | Mode | Smoothness | Amount | Cleaning |
| (1) HP Premium | LTR | 120 g/m² | Gloss | smooth | small | no |
| Presentation | | | | | | |
| Paper 120 g | | | | | | |
| (2) HP Brochure | LTR | 200 g/m² | Gloss | smooth | small | no |
| Paper 200 g | | | | | | |
| (3) Xerox | LTR | 75 g/m² | Normal | ordinary | ordinary | no |
| Business 4200 | | | | | | |
| (4) Oce Red | A4 | 80 g/m² | Normal | ordinary | ordinary | no |
| Label | | | | | | |
| (5) International | LTR | 200 g/m² | Heavy | ordinary | ordinary | no |
| Paper Springhill | | | | | | |
| Index DIGITAL | | | | | | |
| (6) NEENAH | LTR | 75 g/m² | Rough | rough | large | yes |
| 25% COTTON | | | | | | |
| CONTENT | | | | | | |
| (7) NEENAH | LTR | 60 g/m² | Light | rough | large | yes |
| BOND SUB16 | | | Rough | | | |

First, Table 1 shows that there is a high correlation between the surface smoothness and the paper dust amount of each transfer material P. The transfer materials P having a rough surface produce a large amount of paper dust, whereas the transfer materials P having a smooth surface produce a small amount of paper dust. That is, the paper dust amount is larger when the surface smoothness of the transfer material P corresponds to a second roughness than when the surface smoothness of the transfer material P corresponds to a first roughness, the second roughness being greater than the first roughness.

For the transfer materials P whose paper dust amount was “small” or “ordinary”, faulty cleaning did not occur, whereas for the transfer materials P whose paper dust amount was “large”, faulty cleaning occurred. This may be because the paper dust got caught in the blade nip as a result of the amount of supply toner (supply amount) supplied to the blade nip B in the supplying operation not being sufficient.

### 6. Method of Controlling Supplying Operation in the Embodiment

On the basis of the test results above, in this embodiment, in accordance with information regarding the surface smoothnesses of transfer materials P on which images are formed, the weight per unit area of supply toner that is supplied to the blade nip B in the supplying operation (placement amount) is determined. In particular, in the embodiment, on the basis of an image formation mode that is selected when a print job is executed, the surface smoothnesses of the transfer materials P are determined. In accordance with the results of determination, the placement amount of supply toner that is supplied to the blade nip B in the supplying operation is determined. That is, in the embodiment, as information regarding the surface smoothnesses of the transfer materials P, information regarding image formation modes that correlate with the surface smoothnesses of the transfer materials P on which images are formed is used.

In this embodiment, the image forming apparatus 100 can execute a print job in each of the image formation modes (operation settings), that is, “Gloss”, “Normal”, “Heavy”, “Rough”, and “Light Rough”. “Gloss” is an image formation mode in which process conditions, such as process speed, are set so as to be suitable for glossy paper. In general, the surface smoothness of such a transfer material P corresponds to “smooth” above. “Normal” and “Heavy” are image formation modes in which process conditions are set so as to be suitable for plain paper and thick paper, respectively. In general, the surface smoothnesses of these transfer materials P correspond to “ordinary” above. Further, “Rough” and “Light Rough” are image formation modes in which process conditions are set so as to be suitable for rough paper. In general, the surface smoothness of such a transfer material P corresponds to “rough” above. Examples of transfer materials P that are assumed as being suitable for selection of corresponding image formation modes are as indicated in Table 1.

Therefore, for example, when “Gloss” is selected as the image formation mode when a print job is executed, it is possible to determine that the surface smoothness of a transfer material P corresponds to “smooth”. Similarly, for example, when “Rough” or “Light Rough” is selected, it is possible to determine that the surface smoothness of a transfer material P corresponds to “rough”; and when “Normal” or “Heavy” is selected, it is possible to determine that the surface smoothness of a transfer material P corresponds to “ordinary”. Since Table 1 shows that there is no correlation between the paper dust amount and the basis weight, in the embodiment, the placement amount of supply toner that is supplied to the blade nip B is changed on the basis of the surface smoothness regardless of the basis weight.

In the embodiment, the controlling unit 30 determines the surface smoothness of a transfer material P on the basis of information that specifies an image formation mode included in print job data. An operator, such as a user, inputs (or selects) the image formation mode from a printer driver that is installed in an external device 200 (FIG. 1) or from an operating section (operation panel) 120 that is provided at the apparatus main body 110.

In this embodiment, when the controlling unit 30 determines that the surface smoothness of a transfer material P corresponds to “rough”, the paper dust amount is large. Therefore, the placement amount of supply toner that is supplied to the blade nip B is larger than that when the surface smoothness of the transfer material P corresponds to “ordinary”. In contrast, when the controlling unit 30 determines that the surface smoothness of a transfer material P corresponds to “smooth”, the placement amount of supply toner that is supplied to the blade nip B is smaller than that when the surface smoothness of the transfer material P corresponds to “ordinary”. When the surface smoothness of the transfer material P corresponds to “smooth”, supply toner of an amount that is the same as that when the surface smoothness of the transfer material P corresponds to “ordinary” may be supplied to the blade nip B. However, when the surface smoothness corresponds to “smooth”, since the paper dust amount is small, it is possible to prevent paper dust from being caught in the blade nip B by supplying a relatively small amount of supply toner. Therefore, in the embodiment, when the surface smoothness corresponds to “smooth”, by causing the placement amount of supply toner that is supplied to the blade nip B to be less than that when the surface smoothness corresponds to “ordinary”, it is possible to suppress the consumption of toner by the supplying operation to a minimum.

More specifically, when the surface smoothness of a transfer material P corresponds to “ordinary”, the placement amount of supply toner that is supplied to the blade nip B is 0.010 mg/cm². When the surface smoothness of a transfer material P corresponds to “smooth”, the placement amount is 0.005 mg/cm². When the surface smoothness of a transfer material P corresponds to “rough”, the placement amount is 0.015 mg/cm². In the embodiment, the placement amount of supply toner is changed by controlling the output of laser light from an exposure device 20 when forming a supply toner image.

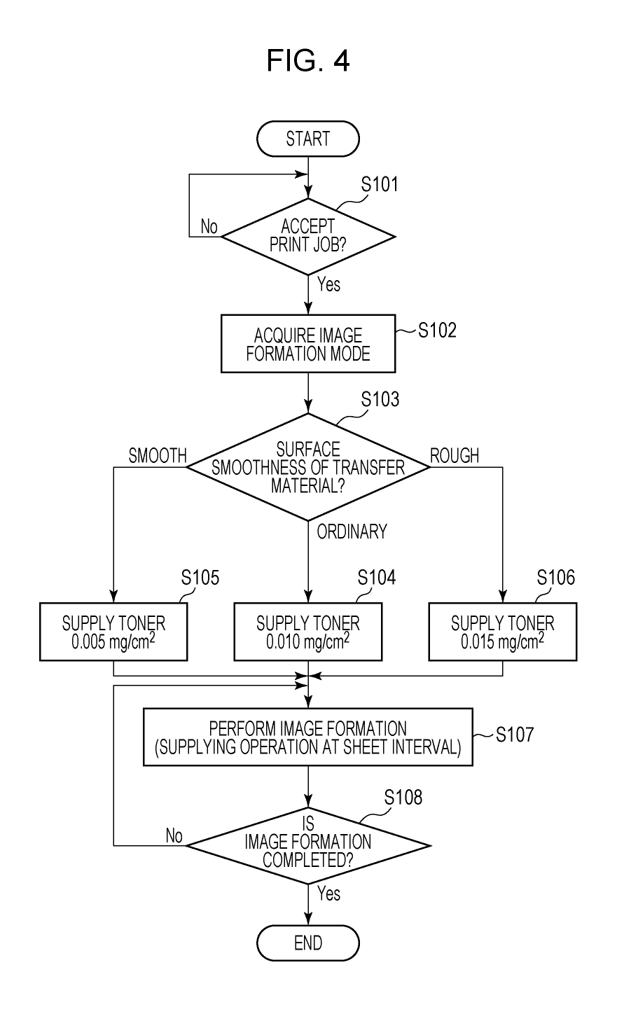

FIG. 4 is a flowchart schematically showing print job control steps including the supplying operation according to the embodiment.

When the controlling unit 30 receives a print job (Step S101), image formation mode information including data regarding the received print job is acquired (Step S102). Next, the controlling unit 30 determines the surface smoothness of a transfer material P on the basis of the acquired print job image formation mode (Step S103). In the embodiment, the controlling unit 30 determines the surface smoothness of the transfer material P in three levels, that is, “smooth”, “ordinary”, and “rough” in accordance with the above-described method of determining the surface smoothness of a transfer material P. Then, in accordance with the determined surface smoothness of the transfer material P, as described above, the placement amount of supply toner that is supplied to the blade nip B in the supplying operation is determined (Steps S104, S105, S107). Thereafter, the controlling unit 30 starts a print job image formation operation and executes the supplying operation for every sheet interval to cause supply toner of an amount determined as mentioned above to the blade nip B (Step S107). In the case of a print job for forming an image on one transfer material P, the supplying operation may be performed in the post-rotating step. After the formation of all images for the print job has ended (Step S108), the controlling unit 30 ends the print job.

The evaluation results of this embodiment in which the above-described control has been executed are shown in Table 2. The evaluation method is the same as that for the comparative examples whose evaluation results are shown in Table 1.

TABLE 2

| | | | Image | | Paper | Toner | |
|---|---|---|---|---|---|---|---|
| Transfer | | Basis | Formation | Surface | Dust | Supply | Faulty |
| Material | Size | Weight | Mode | Smoothness | Amount | Amount | cleaning |
| (1) HP Premium | LTR | 120 g/m² | Gloss | smooth | small | 0.005 mg/cm² | no |
| Presentation | | | | | | | |
| Paper 120 g | | | | | | | |
| (2) HP Brochure | LTR | 200 g/m² | Gloss | smooth | small | 0.005 mg/cm² | no |
| Paper 200 g | | | | | | | |
| (3) Xerox | LTR | 75 g/m² | Normal | ordinary | ordinary | 0.010 mg/cm² | no |
| Business 4200 | | | | | | | |
| (4) Oce Red | A4 | 80 g/m² | Normal | ordinary | ordinary | 0.010 mg/cm² | no |
| Label | | | | | | | |
| (5) International | LTR | 200 g/m² | Heavy | ordinary | ordinary | 0.010 mg/cm² | no |
| Paper Springhill | | | | | | | |
| Index DIGITAL | | | | | | | |
| (6) NEENAH | LTR | 75 g/m² | Rough | rough | large | 0.015 mg/cm² | no |
| 25% COTTON | | | | | | | |
| CONTENT | | | | | | | |
| (7) NEENAH | LTR | 60 g/m² | Light | rough | large | 0.015 mg/cm² | no |
| BOND SUB16 | | | Rough | | | | |

As shown in Table 2, with regard to transfer material P No. 6 and transfer material P No. 7 producing large amounts of paper dust, by increasing the supply amount of supply toner to the blade nip B, faulty cleaning was no longer performed. With regard to transfer material P No. 1 and transfer material P No. 2 producing small amounts of paper dust, faulty cleaning was not performed even though the supply amount of supply toner to the blade nip B was reduced.

In the embodiment, the placement amount of supply toner that is supplied to the blade nip B in one supplying operation (for one sheet interval in the embodiment), that is, the weight per unit area of the supply toner is changed in accordance with the surface smoothness of a transfer material P. However, the total amount of supply toner that is supplied to the blade nip B may be controlled by changing the area of a supply toner image without changing the placement amount of the supply toner. That is, when the supply amount of supply toner to the blade nip B is relatively large, the area of the supply toner image that is formed by the supplying operation is made relatively large. In contrast, when the supply amount of supply toner to the blade nip B is relatively small, the area of the supply toner image that is formed by the supplying operation is made relatively small. It is possible to change the area of the supply toner image by changing the length of the supply toner image in a longitudinal direction thereof, the length of the supply toner image in a transverse direction thereof, or the lengths of the supply toner image in both the longitudinal direction and the transverse direction thereof. Alternatively, it is possible to change the total area of the supply toner image by dividing the supply toner image that is formed in one supplying operation (for one sheet interval in the embodiment) in the movement direction of the intermediate transfer belt 13, a direction substantially orthogonal to the movement direction, or in both the movement direction and a direction substantially orthogonal to the movement direction. The placement amount and the area of the supply toner image may both be changed in accordance with the surface smoothness of the transfer material P.

The timing at which the supplying operation is executed is not limited to the sheet interval step. The supplying operation may be executed at any timing as long as it is performed in the non-image formation period. For example, the supplying operation may be executed in, for example, the post-rotating step or the pre-rotating step.

Although, in the embodiment, the supplying operation is performed for every sheet interval, the supplying operation may be performed in the non-image-forming period (such as the sheet interval step or the post-rotating step) each time a plurality of images are formed. In this case, it may be desirable to supply a larger amount of supply toner to the blade nip B in one supplying operation than that when the supplying operation is performed for every sheet interval. However, it is possible to suppress the occurrence of faulty cleaning by changing the frequency with which the supplying operation is performed in accordance with the surface smoothness of a transfer material P. For example, the placement amount of supply toner that is supplied to the blade nip B in one supplying operation is set at 0.060 mg/cm². When the surface smoothness of a transfer material P corresponds to “ordinary”, the supplying operation is performed for every six prints; when it corresponds to “smooth”, the supplying operation is performed for every twelve prints; and when it corresponds to “rough”, the supplying operation is performed for every four prints. The supply amounts of supply toner to the blade nip B for one printing sheet in these cases are equivalent to the supply amounts in Table 2. It is possible to change both the supply amount or the area of the supply toner image and the frequency with which the supplying operation is performed in accordance with the surface smoothness of the transfer material P.

Although the surface smoothness of a transfer material P is determined in three levels, that is, “smooth”, “ordinary”, and “rough”, the determination of the surface smoothness of a transfer material P is not limited thereto. It may be determined in a larger number of levels; or may be determined in a smaller number of levels.

The method of determining the surface smoothness of a transfer material P is not limited to the determining method based on the image formation mode. For example, an operator may input (or select) information regarding the type of transfer material P from the printer driver that is installed in the external device 200 or from the operating section 120 that is provided at the apparatus main body 110. Here, examples of types of transfer materials P that are input (or selected) are, for example, as shown in Tables 1 and 2. In this case, it is possible to determine the surface smoothness in a larger number of levels than when the surface smoothness is determined on the basis of the image formation mode. For example, with regard to both the transfer material P No. 3 and the transfer material P No. 4 in Table 2, “Normal” is selected as the image information mode. Therefore, when the surface smoothness is determined on the basis of the image formation mode, the supply amounts of supply toner to the blade nip B (including the placement amounts, the areas, and the frequencies with which the supplying operations are performed) are the same. However, the surface smoothness of the transfer material P No. 3 is 33 sec, whereas the surface smoothness of the transfer material P No. 4 is 22 sec, which indicates a relatively rough surface. When the surface smoothness is determined on the basis of the information regarding the type of transfer material P, it is possible to isolate the transfer material P No. 3 and the transfer material P No. 4. Therefore, it is possible to change the supply amount of supply toner to the blade nip B in accordance with the difference between the surface smoothnesses. The type of transfer material P may refer to anything that can be associated with differences in surface smoothness, such as manufacturers, brands, and product numbers of the transfer material P.

If an operator is capable of inputting (or selecting) an item regarding the surface smoothness of a transfer material P and controlling the supply amount of supply toner to the blade nip B in accordance with the input, it is possible to obtain similar advantages. For example, instead of inputting the type of transfer material P as described above, a value that indicates the surface smoothness, such as the Beck smoothness, may be directly input.

Here, the method of inputting information regarding the type of transfer material P and information regarding a value indicating the surface smoothness, such as the Beck smoothness, is not limited to inputting methods at individual image forming apparatuses 100. For example, when an operator, such as a user or a service provider, controls a plurality of image forming apparatuses 100, the aforementioned pieces of information may be input to the plurality of image forming apparatuses 100 from a host apparatus connected to the plurality of image forming apparatuses 100 via a network line. By inputting the aforementioned pieces of information to the plurality of image forming apparatuses 100 from the host apparatus, it is no longer necessary to individually input the aforementioned pieces of information to the image forming apparatuses, as a result of which it is possible to reduce the work load on the operator. The single or plurality of image forming apparatuses and the host apparatus that is connected to the single image forming apparatus or the plurality of image forming apparatuses via the network line and that is used for inputting information regarding the type of transfer material and information regarding a value indicating the surface smoothness constitute an image forming apparatus control system.

In this way, in the embodiment, the image forming apparatus 100 includes the controlling unit 30 that executes a supplying operation in which a supply toner image is formed on the intermediate transfer belt 13 and toner of the supply toner image is supplied to the contact portion (the blade nip B) between the cleaning member and the intermediate transfer belt 13. The controlling unit 30 performs control such that the amount of toner that is supplied to the blade nip B in the supplying operation with respect to the number of transfer materials P on which images are formed becomes as follows. That is, the amount of toner is made smaller when the surface smoothness of a transfer material P on which an image is formed corresponds to the second roughness than when the surface smoothness of the transfer material P on which an image is formed corresponds to the first roughness, the second roughness being greater than the first roughness. In the embodiment, the image forming apparatus 100 is capable of forming images in a plurality of operation settings that correspond with the surface smoothnesses of transfer materials P on which images are formed. The controlling unit 30 determines the surface smoothness of the transfer material P on which an image is formed on the basis of the operation setting specified for the image formation. In another method, the controlling unit 30 is capable of determining the surface smoothness of a transfer material P on which an image is formed on the basis of the type of transfer material P specified as one on which an image is formed or on the basis of a value specified as one indicating the surface smoothness of the transfer material P on which an image is formed. In this case, the image forming apparatus 100 includes the operating section 120 serving as an inputting unit for inputting information regarding the type of transfer material P and information regarding a value indicating the surface smoothness to the controlling unit 30 by an operator. The image forming apparatus/apparatuses 100 may be connected to the apparatus 200 including an inputting unit for inputting information regarding the type of transfer material P and information regarding a value indicating the surface smoothness to the single or the plurality of image forming apparatuses 100 by an operator. In this case, the image forming apparatus 100/apparatuses 100 include a connecting unit (the communication I/F section 30a) that inputs information regarding the type of transfer material P and information regarding a value indicating the surface smoothness input from the apparatus 200 to the controlling unit 30.

In particular, in the embodiment, the controlling unit 30 executes the supplying operation each time images are formed on a predetermined number of transfer materials P. The controlling unit 30 changes the weight per unit area of toner of a supply toner image to change the amount of toner that is supplied to the blade nip B by the supplying operation that is performed on the number of transfer materials P on which images are formed. In place of or in addition to the weight per unit area of the toner of the supply toner image, the area of the supply toner image may be changed. Alternatively, in place of or in addition to the weight per unit area or the area of the toner of the supply toner image, the frequency with which the supplying operation is executed with respect to the number of transfer materials P on which images are formed may be changed.

As described above, according to the embodiment, it is possible to suppress the occurrence of faulty cleaning when using a transfer material P that produces a relatively large amount of paper dust.

### Second Embodiment

Next, another embodiment according to one or more aspects of the present disclosure is described. The basic structure and operation of the image forming apparatus 100 according to a second embodiment are the same as those according to first embodiment. Therefore, elements having functions and structures in the image forming apparatus according to the second embodiment that are the same as or correspond to those of the elements in the image forming apparatus according to the first embodiment are given the same reference numerals and are not described in detail below.

In the second embodiment, the surface smoothness of a transfer material P is determined on the basis of the results of detection by a detecting unit that detects the surface smoothness of the transfer material P. This makes it possible to more precisely determine the surface smoothness of the transfer material P at the image forming apparatus 100 even when an operator inputs (or selects) by mistake, for example, information regarding image formation mode or information regarding the type of transfer material.

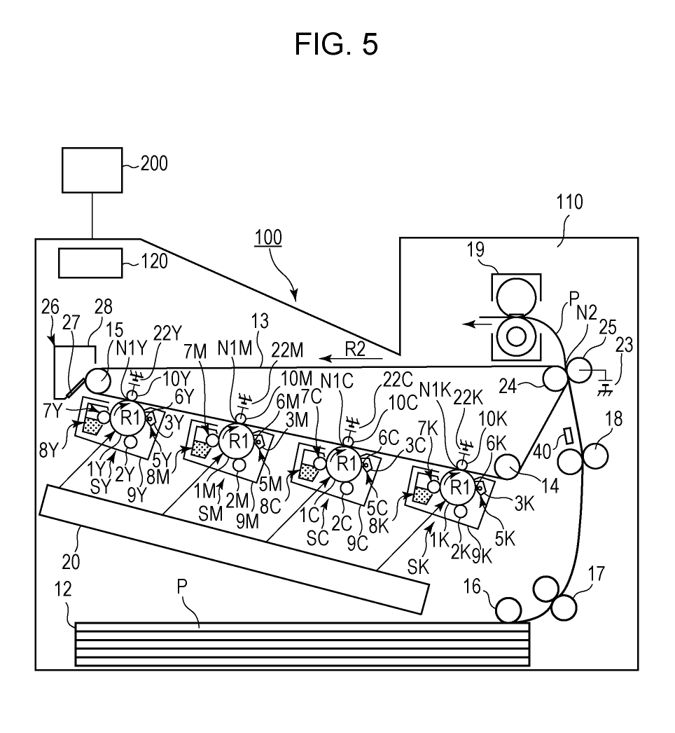

FIG. 5 is a schematic sectional view of the image forming apparatus 100 according to the second embodiment. In the second embodiment, the image forming apparatus 100 includes a detecting section 40 that serves as the detecting unit and that detects the surface smoothness of a transfer material P. The detecting section 40 is disposed downstream from the conveying rollers 18 in the conveying direction of a transfer material P and upstream from the second-transfer portion N2.

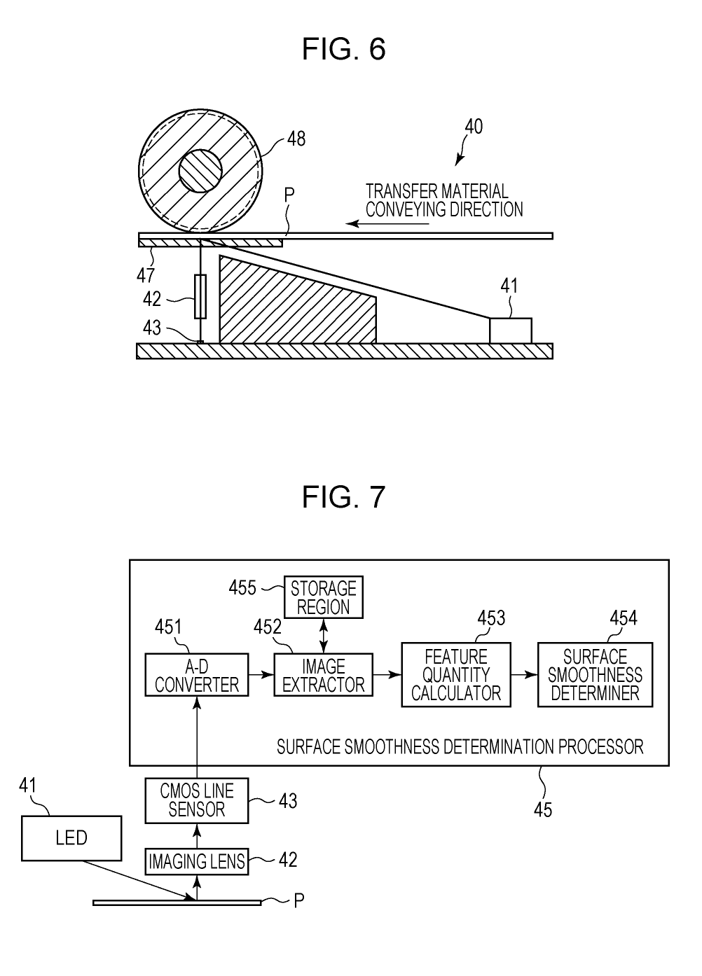

FIG. 6 is a schematic view of the detecting section 40 according to the second embodiment. The detecting section 40 includes a light emitting diode (LED) 41 that serves as an illuminating unit and that illuminates a surface of a transfer material P with light. The detecting section 40 also includes an imaging lens 42 that serves as an imaging unit. The imaging lens 42 receives the light that has been emitted from the LED 41 and that has been reflected from the surface of the transfer material P, and focuses the light. The detecting section 40 further includes a complementary metal-oxide semiconductor (CMOS) line sensor 43 that serves as an image pickup unit and that picks up the light focused by the imaging lens 42. A location in the conveying direction of the transfer material P where the light emitted from the LED 41 is reflected by the transfer material P is a reflecting portion. The reflected light reflected by the reflecting portion is picked up as a surface image of the transfer material P by the CMOS line sensor 43. The detecting section 40 further includes a protecting member 47 that protects the imaging lens 42 and the LED 41. The detecting section 40 further includes a pressing member 48 that is disposed so as to oppose the protecting member 47 and that presses down the transfer material P conveyed between it and the protecting member 47 against the protecting member 47. In the second embodiment, a white LED is used as the LED 41. If the LED 41 is capable of illuminating the transfer material P, the LED is not limited to a white LED. In the second embodiment, the light with which the transfer material P is illuminated by the LED 41 illuminates the transfer material P at an angle of 10 degrees with respect to the surface of the transfer material P. This angle is only an example. As long as the angle allows an image that is good enough to determine the surface smoothness of the transfer material P to be acquired, the angle is not limited to 10 degrees. Although, in the second embodiment, the CMOS line sensor 43 is used as the image pickup unit, the image pickup unit is not limited thereto. For example, a two-dimensional area sensor may also be used.

FIG. 7 is a block diagram of an exemplary control mode of the detecting section 40. Light from the LED 41 illuminates ae surface of a transfer material P that is conveyed with respect to the aforementioned reflecting portion. The reflected light from the transfer material P is focused by the imaging lens 42, and surface images are picked up by the CMOS line sensor 43. The surface images of the transfer material P picked up by the CMOS line sensor 43 are output to a surface smoothness determination processor 45 that serves as a determining unit. The surface smoothness determination processor 45 performs analog to digital conversion on the received surface images of the transfer material P by using an analog to digital (A/D) converter 451, and acquires an image on one same line that is substantially orthogonal to the conveying direction of the transfer material P. In the second embodiment, an 8-bit A/D conversion integrated circuit (IC) is used as the A/D converter 451, and the A/D converter 451 outputs values from 0 to 255. Next, at an image extractor 452 and a storage region 455, the surface images of the transfer material P received from the A/D converter 451 are connected to each other in the conveying direction of the transfer material P, so that a two-dimensional surface image is acquired. In the second embodiment, the conveying speed of the transfer material P when the surface smoothness is detected by the detecting section 40 is 210 mm/sec, and the resolution of the CMOS line sensor 43 is 400 dpi per line (approximately 42 μm for one dot). The image size is, for example, 236 dots×118 dots. In this case, a region equivalent to 10 mm×5 mm of the transfer material P can be picked up. The pickup operation by the CMOS line sensor 43 is performed at 42 μm/(210 mm/sec) and at an interval of approximately 200 μsec. This makes it possible to perform the pickup operation such that pickup areas on the transfer material P do not overlap.

From the acquired two-dimensional surface image, the image extractor 452 extracts the surface image used for determining the type of transfer material P on the basis of information regarding, for example, an effective image range and an optical axis stored in the storage region 455. At this time, in order to determine the surface smoothness of the transfer material P, the surface image is subjected to shading correction (that is, an operation of removing unevenness from an image having uneven density). A feature quantity calculator 453 calculates the feature quantity on the basis of the acquired surface image. An exemplary method of calculating the feature quantity is described below. A surface smoothness determiner 454 determines the surface smoothness of the transfer material P on the basis of the result of calculation by the feature quantity calculator 453.

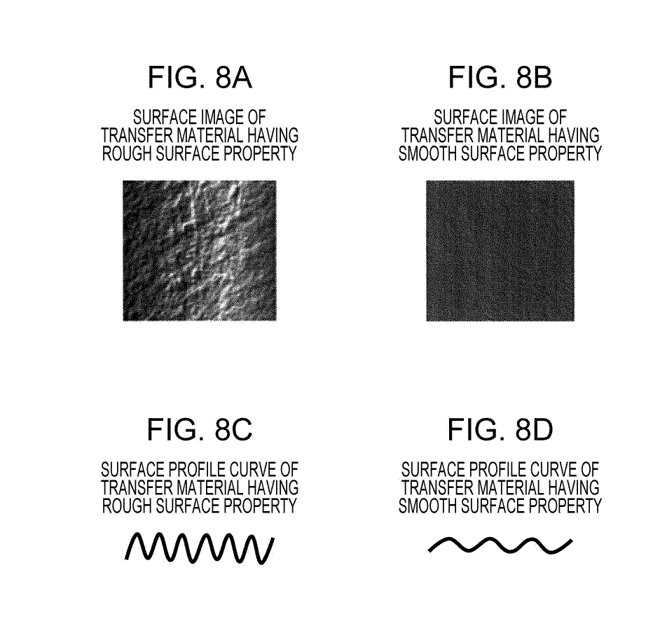

FIGS. 8A and 8B each show part of a surface image of a transfer material P acquired as described above. In the case of a transfer material P having a rough surface, a surface image shown in FIG. 8A is acquired. When any one-line data of the surface image is extracted, a surface profile curve shown in FIG. 8C is acquired. In contrast, in the case of a transfer material P having a smooth surface, a surface image shown in FIG. 8B is acquired. When any one line data of the surface image is extracted, a surface profile curve shown in FIG. 8D is acquired.

Therefore, by calculating, for example, Rz (maximum unevenness difference) of the acquired surface profile curve or difference integrated value with respect to an adjacent dot (length of the surface profile curve) as an example of the aforementioned feature quantity, it is possible to convert into numbers the feature of the surface smoothness of the transfer material P. In the second embodiment, the difference integrated value with respect to an adjacent dot is used as the feature quantity.

Similarly to the first embodiment, the results of determination of the surface smoothness of a transfer material P can be classified in three levels, that is, “rough”, “ordinary”, and “smooth”. In the second embodiment, the surface smoothness of a transfer material P whose difference integrated value is less than 360,000 corresponds to “smooth”. The surface smoothness of a transfer material P whose difference integrated value is greater than or equal to 360,000 and less than 850,000 corresponds to “ordinary”. The surface smoothness of a transfer material P whose difference integrated value is greater than or equal to 850,000 corresponds to “rough”. Here, for example, the numerical value “850,000” indicates a difference integrated value with respect to a region of 236×118=27,848 dots, and the average value of the difference with respect to the adjacent dot is 850,000/27,848≈30.5. Therefore, in other words, the difference average value with respect to the adjacent dot where the surface smoothness is determined as corresponding to “rough” is greater than or equal to 30.5. In this way, it is possible to determine the surface smoothness of the transfer material P and control the supply amount of supply toner to the blade nip B as in the first embodiment. In addition, the same results as those shown in Table 2 described in the first embodiment can be obtained.

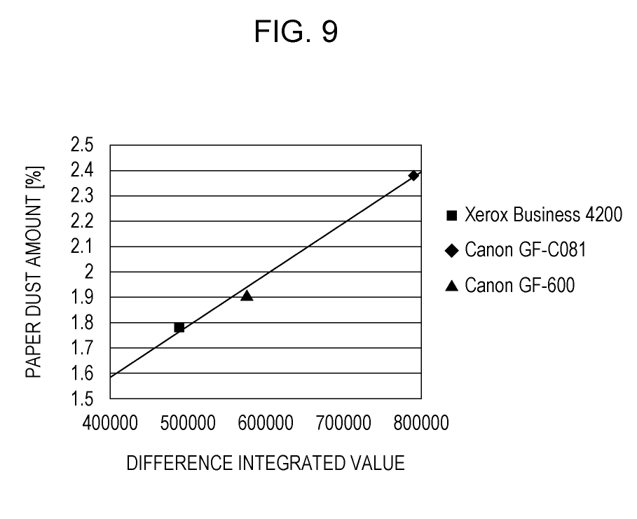

On the basis of the results of detection by the detecting section 40, instead of determining the surface smoothness of the transfer material P in three levels, that is, “rough”, “ordinary”, and “smooth”, it is possible to determine the surface smoothness of the transfer material P in a larger number of levels. FIG. 9 shows, as an example, the results of correlation between the difference integrated value, which is determined by integrating the difference from an adjacent dot of one line, and the paper dust amount on the basis of the surface image acquired by the detecting section 40, the correlation being for transfer materials P of three types, that is, transfer material P No. 1 to transfer material P No. 3 in Table 3. The paper dust amount is measured by the same method described in the first embodiment.

FIG. 9 shows that there is a high correlation between the difference integrated value that is determined on the basis of the results of detection by the detecting section 40 and the paper dust amount. That is, the surface property of a transfer material P is such that the surface property of the transfer material P is rougher when the difference integrated value is a second value than when the difference integrated value is a first value, the second value being larger than the first value. In addition, the paper dust amount is larger when the difference integrated value is the second value than when it is the first value. Therefore, on the basis of the difference integrated value for any transfer material P, an optimum supply amount of supply toner to the blade nip B that corresponds to the paper dust amount of the transfer material S can be set. That is, the relationship between the difference integrated value and the optimum supply amount of supply toner to the blade nip B (such as the placement amount) is previously determined and stored in the controlling unit 30. Instead of performing Steps S103 to S106 in FIG. 4 in the first embodiment, the controlling unit 30 can determine the supply amount of the supply toner to the blade nip B on the basis of the difference integrated value determined on the basis of the results of detection by the detecting section 40 and the aforementioned previously determined relationship.

Table 3 shows the results of evaluation when an optimum supply amount of supply toner to the blade nip B (here, the placement amount) is calculated on the basis of the difference integrated value, and the supplying operation is performed by the same method as in the first embodiment. The evaluating method used is the same as that used to obtain the results in Table 1.

TABLE 3

| | | | Image | Toner | |
|---|---|---|---|---|---|
| Transfer | | Basis | Formation | Supply | Faulty |
| Material | Size | Weight | Mode | Amount | Cleaning |
| (1) Canon | A4 | 81 g/m² | Normal | 0.007 mg/cm² | no |
| GF-C081 | | | | | |
| (2) Canon | A4 | 60 g/m² | Normal | 0.008 mg/cm² | no |
| GF-600 | | | | | |
| (3) Xerox | LTR | 75 g/m² | Normal | 0.010 mg/cm² | no |
| Business | | | | | |
| 4200 | | | | | |

As shown in Table 3, it is possible to suppress the occurrence of faulty cleaning for all of the transfer materials P. In this way, by continuously setting proper supply amounts of supply toner to the blade nip B, a transfer material P of any type and having any surface smoothness can be used.

As described above, in the second embodiment, the image forming apparatus 100 includes the detecting section 40 that detects the surface smoothness of a transfer material P on which an image is formed. The controlling unit 30 determines the surface smoothness of the transfer material P on which an image is formed on the basis of the results of detection by the detecting section 40. This makes it possible to suppress the occurrence of faulty cleaning even when an operator inputs (or selects) by mistake, for example, information regarding image formation mode or information regarding the type of transfer material P. That is, it is possible to supply toner to the blade nip B by a proper amount corresponding to the surface smoothness of the transfer material P even when, for example, an operator selects by mistake an image formation mode not corresponding to the surface smoothness of the transfer material P.

### Others

Although one or more aspects of the present disclosure are described in accordance with specific embodiments above, the present disclosure is not limited to the above-described embodiments.

The supplying operation according to one or more aspects of the present disclosure are particularly effective when the transfer material and the image carrying member contact each other. Therefore, similar advantageous effects can be obtained even in an image forming apparatus that uses a method in which a toner image on a photoconductor is directly transferred to the transfer material, the photoconductor being the image carrying member. A well-known image forming apparatus that uses a direct transfer system that includes, in place of the intermediate transfer belt according to the above-described embodiments, a transfer material carrying member (conveying belt) as the transfer material carrying member that carries and conveys the transfer material. In the image forming apparatus, a toner image is directly transferred to the transfer material carried by the transfer material carrying belt from the photoconductor. In such an image forming apparatus, paper dust may be transferred directly to the photoconductor from the transfer material or may be transferred to the photoconductor from the transfer material via the transfer material carrying belt, and may get caught between the photoconductor and the blade. Therefore, in such an image forming apparatus, it is possible to suppress the occurrence of faulty cleaning by executing the supplying operation in which supply toner is supplied to the contact portion between the photoconductor and the blade. At this time, as in the above-described embodiments, the supply amount of supply toner to the contact portion between the photoconductor and the blade (including the placement amount, the area, and the frequency with which the supply toner is supplied) may be changed in accordance with the surface smoothness of the transfer material.

The image forming apparatus is not limited to a color image forming apparatus. The image forming apparatus may also be applied to, for example, a monochromatic image forming apparatus including only one photoconductor as the image carrying member.

The photoconductor is not limited to one having the form of a drum. The photoconductor may be one having the form of, for example, an endless belt. The intermediate transfer member is not limited to an endless belt. The intermediate transfer member may have the form of, for example, a drum in which a film (sheet) is stretched on a frame.

The present disclosure particularly provides operational effects when the cleaning member is a cleaning blade. However, the cleaning member is not limited to one having the form of a blade. Regarding a cleaning member that may perform faulty cleaning due to paper dust being caught in the blade nip, such as a cleaning member having the form of a block (a pad), it is possible to expect the same advantageous effects by the application of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-121017 filed Jun. 17, 2016, which is hereby incorporated by reference herein in its entirety.

What is claimed is:

1. An image forming apparatus comprising:
an image carrying member that carries a toner image;
a transfer member that forms a transfer portion with the image carrying member and that transfers the toner image to a transfer material from the image carrying member at the transfer portion;
a cleaning member that is disposed so as to contact a surface of the image carrying member and that removes toner from the surface of the image carrying member;
a supplying device that supplies supply toner to the image carrying member; and
a controlling unit that executes a supply mode in which the supply toner is supplied to the image carrying member from the supplying device and the supply toner on the image carrying member is supplied to a contact portion between the cleaning member and the image carrying member,
wherein the controlling unit determines a surface smoothness of the transfer material that passes through the transfer portion before the supply toner is supplied to the contact portion in the supply mode, and controls the supplying device such that a first amount that is supplied to the contact portion when the surface smoothness corresponds to a first roughness is smaller than a second amount that is supplied to the contact portion when the surface smoothness corresponds to a second roughness, the second roughness being greater than the first roughness.

2. The image forming apparatus according to claim 1,
wherein the controlling unit is capable of performing image formation in a plurality of operation settings corresponding to the surface smoothness of the transfer material that passes through the transfer portion, and
wherein the controlling unit determines the surface smoothness of the transfer material on which an image is formed based on an operation setting specified for the image formation.

3. The image forming apparatus according to claim 1,
wherein the controlling unit determines the surface smoothness of the transfer material that passes through the transfer portion based on a type of transfer material specified as one on which an image is formed.

4. The image forming apparatus according to claim 3, further comprising:
an inputting unit that is used by an operator to input information regarding the type of transfer material to the controlling unit, or a connecting unit that is connected to a device including an inputting unit that is used by the operator to input the information regarding the type of transfer material to the image forming apparatus or to a plurality of the image forming apparatuses, the connecting unit inputting the information regarding the type of transfer material input from the device to the controlling unit.

5. The image forming apparatus according to claim 1,
wherein the controlling unit determines the surface smoothness of the transfer material that passes through the transfer portion based on a value specified as one that indicates the surface smoothness of the transfer material that passes through the transfer portion.

6. The image forming apparatus according to claim 1, further comprising:
an inputting unit that is used by an operator to input information regarding a value indicating the surface smoothness of the transfer material to the controlling unit.

7. The image forming apparatus according to claim 1, further comprising:
a connecting unit that is connected to a device including an inputting unit that is used by an operator to input information regarding a value indicating the surface smoothness of the transfer material to the image forming apparatus or to a plurality of the image forming apparatuses, the connecting unit inputting the information regarding the value indicating the surface smoothness of the transfer material input from the device to the controlling unit.

8. The image forming apparatus according to claim 1, further comprising:
a detecting unit that detects the surface smoothness of the transfer material that passes through the transfer portion,
wherein the controlling unit determines the surface smoothness of the transfer material that passes through the transfer portion based on a result of detection by the detecting unit.

9. The image forming apparatus according to claim 1,
wherein the controlling unit changes a toner amount that is supplied to the contact portion in the supply mode by changing a weight per unit area of the supply toner.

10. The image forming apparatus according to claim 1,
wherein the controlling unit changes a toner amount that is supplied to the contact portion in the supply mode by changing an area of the supply toner.

11. The image forming apparatus according to claim 1,
wherein the controlling unit changes a toner amount that is supplied to the contact portion in the supply mode by changing a frequency with which the supply mode is executed.

12. The image forming apparatus according to claim 1,
wherein the cleaning member is a cleaning blade.

13. The image forming apparatus according to claim 1,
wherein the image carrying member is a photoconductor.

14. The image forming apparatus according to claim 1,
wherein the image carrying member is an intermediate transfer member.
